(19) United States
(12) Patent Application Publication
(10) Pub. No.: US 2022/0107830 A1
(43) Pub. Date: Apr. 7, 2022

(54) ACCESS CONTROL TO GUARDED OBJECTS

(71) Applicant: VMWARE, INC., Palo Alto, CA (US)

(72) Inventors: AKASH KODENKIRI, Bangalore (IN); AMMAR RIZVI, Bangalore (IN); SACHIN JOHRI, Bangalore (IN); KRISHNENDU GORAI, Bangalore (IN); SANDEEP SINHA, Bangalore (IN)

(21) Appl. No.: 17/101,007

(22) Filed: Nov. 23, 2020

(30) Foreign Application Priority Data
Oct. 7, 2020 (IN) 202041043702

(51) Int. Cl. G06F 9/455

(52) U.S. Cl. CPC G06F 9/45558; G06F 2009/45562; G06F 2009/45583; G06F 2009/45575; G06F 2009/4557

(57) ABSTRACT

In one example, a computer implemented method may include designating a configurable object as a guarded object to restrict access to the configurable object. Further, the method may include receiving a request to access the guarded object and determining whether the request is received from a user having a privilege to access the guarded object. Furthermore, the method may include controlling the access to the guarded object based on the determination.

### RELATED APPLICATIONS

Benefit is claimed under 35 U.S.C. 119(a)-(d) to Foreign Application Serial No. 202041043702 filed in India entitled “ACCESS CONTROL TO GUARDED OBJECTS”, on Oct. 7, 2020, by VMware, Inc., which is herein incorporated in its entirety by reference for all purposes.

### TECHNICAL FIELD

The present disclosure relates to computing environments, and more particularly to methods, techniques, and systems for controlling access to guarded objects in a cloud computing infrastructure.

### BACKGROUND

Virtual computing instances (VCIs), such as virtual machines (VMs), virtual workloads, data compute nodes, clusters, containers, and the like, have been introduced to lower data center capital investment in facilities and operational expenses and reduce energy consumption. A VCI is a software implementation of a computer that executes application software analogously to a physical computer. Vas have the advantage of not being bound to physical resources, which allows Vas to be moved around and scaled to meet changing demands of an enterprise without affecting the use of the enterprise's applications. Vas can be deployed on a hypervisor provisioned with a pool of computing resources (e.g., processing resources, memory resources, and the like). Multiple Vas can be configured to be in communication with each other in a distributed computing system (e.g., a software defined data center). Such a system can include various configurable objects/components. Example configurable objects may include portgroups, desktop virtualization solutions (DVS), resource pools, VM containers for multiple VMs (e.g., vAPP), virtual infrastructure resource management components (e.g., VCD), and/or other VM objects.

### BRIEF DESCRIPTION OF THE DRAWINGS

FIG. 1 is a block diagram of an example management node, including a tracking unit to manage an operation on a guarded object;

FIG. 2 is a block diagram of an example computing environment, including the management node of FIG. 1 to manage configurable objects;

FIG. 3 is a flowchart illustrating an example method for controlling access to a guarded object; and

FIG. 4 is a block diagram of an example computing device including non-transitory machine-readable storage medium storing instructions to manage a restricted operation on a guarded object.

The drawings described herein are for illustration purposes only and are not intended to limit the scope of the present subject matter in any way.

### DETAILED DESCRIPTION

The term “virtual computing instance (VCI)” may cover a range of computing functionality. Vas may include non-virtualized physical hosts, virtual machines (VMs), and/or containers. Containers can run on a host operating system without a hypervisor or separate operating system, such as a container that runs within Linux. A container can be provided by a VM that includes a container virtualization layer (e.g., Docker). A VM refers generally to an isolated user space instance, which can be executed within a virtualized environment. Other technologies aside from hardware virtualization can provide isolated user space instances, also referred to as VCIs. The term “VCI” covers these examples and combinations of different types of VCIs, among others.

The VMs, in some examples, may operate with their own guest operating systems on a host using resources of the host virtualized by virtualization software (e.g., a hypervisor, VM monitor, and the like). The tenant (i.e., the owner of the VM) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VM segregation that may be offered in hypervisor-virtualized environments that virtualize system hardware, and thus can be viewed as a form of virtualization that isolates different groups of applications that operate in different containers.

Multiple Vas can be configured to be in communication with each other in a distributed computing system (e.g., a software defined data center). Such a system can include various configurable components/objects, for example, configurable virtual components. A virtual component is a component of a system (e.g., a distributed computing system) that is defined virtually (e.g., via executable instructions) and provisioned physically (e.g., via processor and/or memory resources, and the like). As used herein, “configurable components” may include virtual components that are configurable via executable instructions to setup, change, and/or maintain the infrastructure of a distributed computing system. Some examples of configurable components may include VMs, data centers, hosts, portgroups, desktop virtualization solutions (DVS), resource pools, VM containers for multiple VMs (e.g., vAPP), virtual infrastructure resource management components (e.g., VCD), and/or other VM objects. In some examples, configurable components can include a combination of software and/or hardware (e.g., a pool of computing resources), but at least include hardware configured to perform operations, control, or otherwise manipulate the infrastructure of a distributed computing system (e.g., a cloud environment, a virtualized environment, or the like).

Such a distributed computing system can include thousands of configurable components, such as VCIs, which can be associated with a plurality of data centers. In addition to examples described above, other examples of configurable components may include virtual storage adapters, virtual network interface controllers (NICs), virtual switches, portgroups, profiles, roles, permissions, and the like. The distributed computing system architecture can be managed by one or more administrators, which can lead to configuration setting changes being obfuscated to the user. As used herein, a “configuration setting” is an arrangement of resources assigned to various configurable components in a distributed computing system.

In some examples, an administrator may create and configure a virtual component. In other examples, the administrator may enable a user (e.g., owner) to create and configure the virtual component. For example, using the hypervisor, the administrator or the owner of a VM can create, configure, and manage the operation of the VM.

In such a scenario, an administrator or owner's configurations may be visible to other administrators or users in the system. Further, the other users may be able to modify or delete the configurations either intentionally (e.g., for their infrastructure to be up, to run mission critical applications, or the like) or accidentally, for instance, that can cause a network outage. Further, keeping track of various activities carried out by other users/administrators on a virtual component or a configuration setting of the virtual component may be challenging, particularly, in a significantly large and distributed computing systems. Furthermore, educating the administrators or users not to modify the configurations which belongs to other administrators or users may be a tedious task. Thus, keeping components and corresponding configurations intact or restricting other users or administrators carrying out disastrous operations on the components may be a challenging task.

Examples described herein may provide a management node to designate a configurable object/virtual component in a cloud computing environment as a guarded object to restrict an operation to be performed on the guarded object by users other than an owner of the object or a privileged user of the object. Thus, examples described herein may lock the configurable object (e.g., a configuration setting of the object) to other users in the cloud computing environment.

In one example, the management node may enable a first user to create a configurable object. Further, the management node may designate the configurable object as a guarded object to restrict an operation to be performed on the guarded object. During operation, the management node may receive a request to perform the operation on the guarded object from a second user. Further, the management node may determine whether the second user has a privilege to perform the operation on the guarded object. In one example, the management node may permit the second user to perform the operation on the guarded object when the second user has the privilege to perform the operation. In another example, the management node may deny the request to perform the operation on the guarded object when the second user is not having the privilege to perform the operation.

Further, the management node may send a notification to the first user to indicate that the second user has attempted to access the guarded object. Furthermore, the management node may maintain an audit trail to record the information corresponding to the second user, an access to the guarded object is permitted or denied, and/or a change to the guarded object (e.g., based on the operation performed on the guarded object).

Thus, examples described herein may provide persistence of a configurable component configuration in the cloud or virtual computing infrastructure by locking the component with “do not delete/modify feature”. Further, examples described herein may notify the owner of the component that a user tried to access (e.g., to delete or modify) the component or the configuration, which may assist the owner of the component to take precautionary measures.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

The terms “objects”, “component”, and virtual component” may be used interchangeably throughout the document and may refer components that are configurable via executable instructions to setup, change, and/or maintain the infrastructure of a distributed computing system (e.g., a cloud environment, a virtualized environment, or the like).

System Overview and Examples of Operation

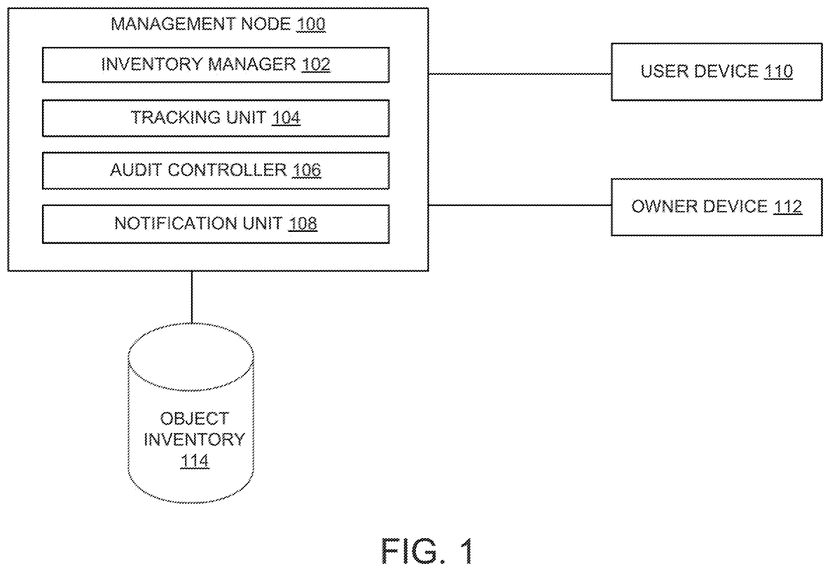

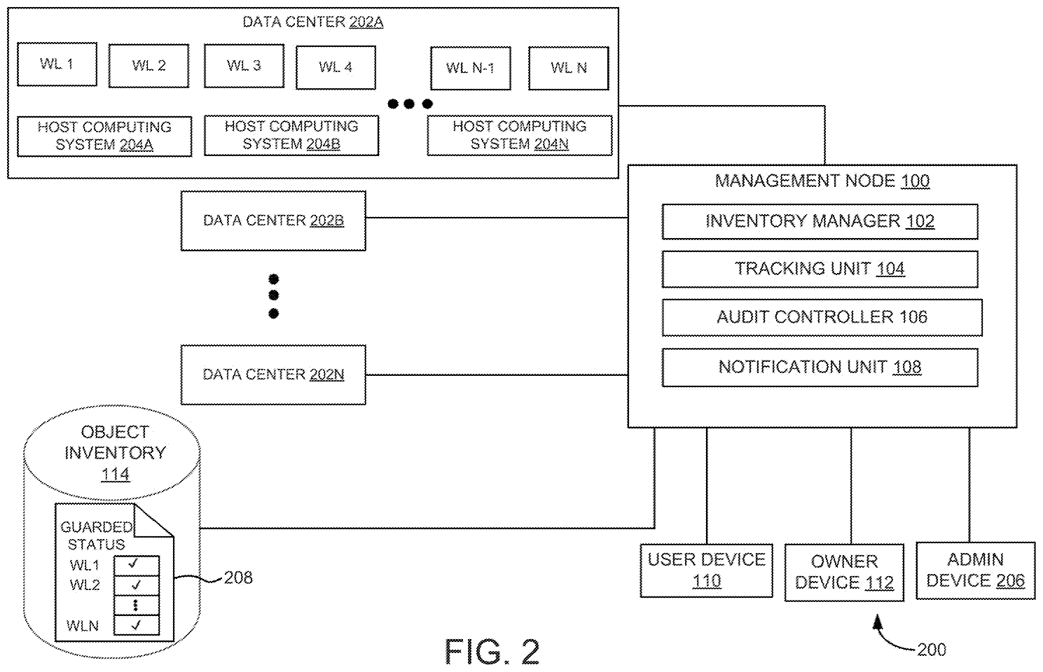

FIG. 1 is a block diagram of an example management node 100, including a tracking unit 104 to manage an operation on a guarded object. Example management node 100 may manage different objects in a distributed computing environment such as a cloud computing environment (e.g., a virtualized cloud computing infrastructure such as VMware vSphere®). For example, management node 100 may execute centralized management services that may be interconnected to manage the objects centrally in the virtualized cloud computing infrastructure. Example centralized management service may be a part of vCenter Server™ and vSphere® program products, which are commercially available from VMware. In an example, an object may include a configurable hardware component, virtual component, storage component, or networking component in the cloud computing infrastructure. Example cloud computing infrastructure and different objects are described in FIG. 2.

In some examples, the cloud computing infrastructure may be managed by one or more administrators via management node 100. In an example, an administrator can create and configure the objects. In another example, the administrator may enable a user (e.g., owner) to create and configure the objects. As shown in FIG. 1, management node 100 may be communicatively coupled with an object inventory 114 to store information of the objects (e.g., a number of objects configured, configuration settings of the objects, and the like) in the cloud computing infrastructure. Example object inventory 114 may be a database either embedded within vCenter or external to vCenter, a flat file, or the like.

As shown in FIG. 1, management node 100 may include an inventory manager 102 to enable a first user (e.g., via an owner device 112) to create a configurable object. Example inventory manager 102 may enable the first user or an administrator to assign a privilege (e.g., to access to the configurable object, perform an operation on the configurable object, and the like) to a second user upon creating the configurable component. Further, inventory manager 102 may designate the configurable object as a guarded object to restrict an operation to be performed on the guarded object. For example, the configurable object may be designated as the guarded object upon a request from the first user. In one example, inventory manager 102 may enable to make a change to a configuration setting of the configurable object to designate the configurable object as the guarded object. In another example, inventory manager 102 may enable to tag the configurable object to designate the configurable object as the guarded object. Further, object inventory 114 may store configuration information of the configurable object indicating whether the configurable object is designated as the guarded object.

During operation, inventory manager 102 may receive a request to perform the operation on the guarded object from the second user (e.g., via a user device 110). Example operation may include modifying a configuration setting of the guarded object, accessing the guarded object, performing an operating system command on the guarded object, powering on the guarded object, powering off the guarded object, suspending the guarded object, rebooting the guarded object, migrating the guarded object, or the like.

Further, management node 100 may include tracking unit 104 to determine whether the second user has a privilege to perform the operation on the guarded object. Further, tracking unit 104 may permit the second user to perform the operation on the guarded object when the second user has the privilege to perform the operation. In another example, tracking unit 104 may deny the request to perform the operation on the guarded object when the second user is not having the privilege to perform the operation. Thus, the guarded object may be visible to other users in the cloud computing infrastructure, however, the other users (e.g., without having the privilege) may not be able to perform the operation on the guarded object. Thus, management node 100 described herein may lock an object or a configuration setting of the object with do not delete/modify feature to the object or the configuration setting.

As shown in FIG. 1, management node 100 may include a notification unit 108 to send a notification to the first user upon denying the request to perform the operation. Example notification may indicate that the second user has attempted to access the guarded object. Furthermore, management node 100 may include an audit controller 106 to maintain an audit trail to record the information corresponding to the second user, an access to the guarded object is permitted or denied, and/or a change to the guarded object (e.g., a change to the configuration setting of the guarded object).

In some examples, the functionalities described in FIG. 1, in relation to instructions to implement functions of inventory manager 102, tracking unit 104, audit controller 106, notification unit 108, and any additional instructions described herein in relation to the storage medium, may be implemented as engines or modules including any combination of hardware and programming to implement the functionalities of the modules or engines described herein. The functions of inventory manager 102, tracking unit 104, audit controller 106, and notification unit 108 may also be implemented by a respective processor. In examples described herein, the processor may include, for example, one processor or multiple processors included in a single device or distributed across multiple devices.

FIG. 2 is a block diagram of an example computing environment 200, including management node 100 of FIG. 1 to manage configurable objects. Example configurable objects may include components in data centers 202A to 202N such as host computing systems 204A to 204N, workloads WL1 to WLN (e.g., virtual machines (VMs), containers, and the like). As shown in FIG. 2, computing environment 200 may include multiple data centers 202A to 202N. A data center may be a physical data center (e.g. an on-premise enterprise computing environment) and/or virtual data center (e.g., a cloud computing environment, a virtualized environment, or the like). The virtual data center may be a pool or collection of cloud infrastructure resources designed for enterprise needs. Further, the virtual data center may be a virtual representation of a physical data center, complete with servers, storage clusters, and networking components, all of which may reside in virtual space being hosted by one or more physical data centers.

As shown in FIG. 2, each data center (e.g., 202A) may include multiple application hosts (e.g., host computing systems 204A to 204N) executing a plurality of applications. Example application host may be a physical computer (e.g., 204A to 204N), a workload (e.g., WL1 to WLN such as a VM, a container, or the like), and the like. The physical computer may be a hardware-based device (e.g., a personal computer, a laptop, or the like) including an operating system (OS) and executing applications. The VM may operate with its own guest OS on the physical computer using resources of the physical computer virtualized by virtualization software (e.g., a hypervisor, a VM monitor, and the like). The container may be a data computer node that runs on top of a host OS without the need for a hypervisor or separate OS. In some examples, each physical computer 204A to 204N may run a hypervisor that creates and runs VMs.

As shown in FIG. 2, computing environment 200 may include a management node 100 communicatively coupled to data centers 202A to 202N via a network. Example network can be a managed Internet protocol (IP) network administered by a service provider. For example, the network may be implemented using wireless protocols and technologies, such as Wi-Fi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

In an example, inventory manager 102 may enable a first user (e.g., an owner) to create a configurable object. Further, inventory manager 102 may designate the configurable object as a guarded object to restrict an operation to be performed on the guarded object. For example, a hypervisor may include a feature that allows the owner of the VM to designate the VM as the guarded object. In an example, inventory manager 102 may provide a user interface (UI) to centrally provision and manage the configurable objects, including the ability to lock a configurable object. Further, inventory manager 102 may include a web client that allow the owner to manage the configurable object from a browser. For example, an administrator may use an admin device 206 and the owner may user an owner device 112 to remotely provision and manage the configurable objects.

In an example, when the configurable object is created, inventory manager 102 may register the configurable object in object inventory 114. Further, object inventory may indicate a guarded status 208 of the configurable object, i.e., whether the configurable object is guarded or not as shown in FIG. 2. Example guarded status 208 may be included a file, a table, or any other data structure. In an example, when the configurable object is designated as the guarded object, restricted operations may be disabled on the configurable object. Further, the owner of the configurable object can assign a privilege to a user or a group of users.

During operation, when a second user (e.g., via a user device 110) tries to access the guarded object, tracking unit 114 may determine whether the second user has a privilege to perform the operation on the guarded object. Further, tracking unit 114 may permit the second user to perform the operation on the guarded object when the second user has the privilege to perform the operation. In other example, tracking unit 114 may deny the request to perform the operation on the guarded object when the second user is not having the privilege to perform the operation. Upon denying the request to perform the operation, notification unit 108 may send a notification to the owner to indicate that the second user has attempted to access the guarded object.

In an example, audit controller 106 may maintain an audit trail. For example, when the configurable object is created or added, audit information of privilege state change and access (e.g., failed as well as success) may be maintained by audit controller 106.

With examples described herein, the administrator or owner can maintain their infrastructure components or configuration without any other's interference. For example, when the owner invokes a tool persistence of configurable component configuration, then any operation of vCenter servers like storage profiles operation, host profile, vSAN, cluster, networking operation, memory, compute operations, or the like may be restrictive to other users. Thus, chances of failure/downtime, or maintenance of the cloud computing infrastructure (e.g., due to network, compute, storage, data center, or the like) may be reduced as un-intentional or unplanned activities on the cloud computing infrastructure can be restricted. Further, examples described herein may reduce troubleshoot in the cloud computing infrastructure and improve infrastructure stability. Also, examples described herein may provide a significantly higher security for the cloud computing environments.

Example Processes

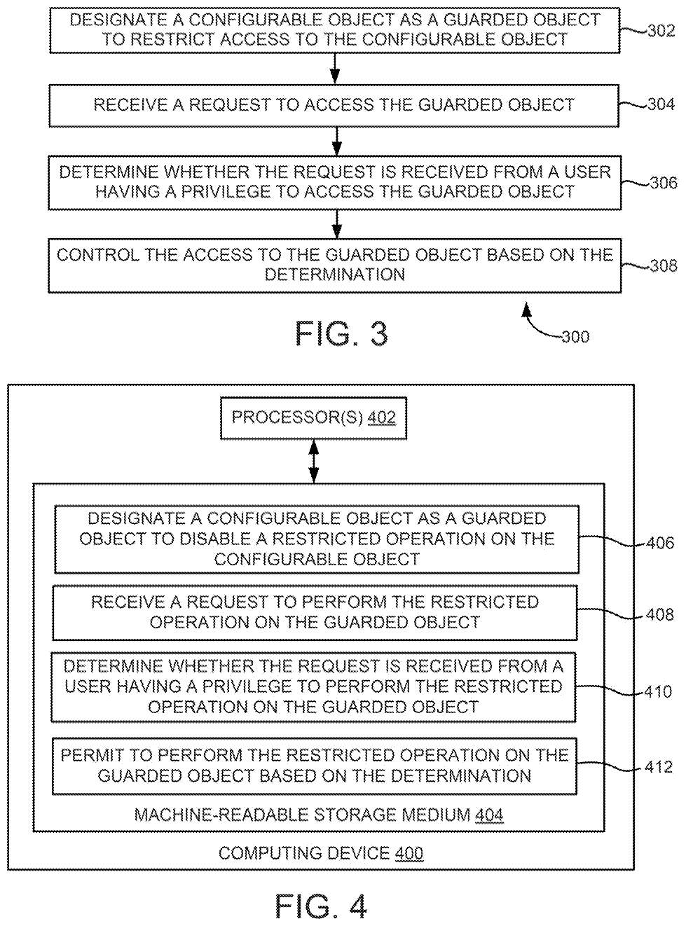

FIG. 3 is a flowchart illustrating an example method 300 for controlling access to a guarded object. It should be understood that the process depicted in FIG. 3 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 302, a configurable object may be designated as a guarded object to restrict access to the configurable object. Example configurable object may include a configurable hardware component, virtual component, storage component, or networking component in a cloud computing infrastructure. In an example, the configurable object may be designated as the guarded object by making a change to a configuration setting of the configurable object to designate the configurable object as the guarded object. In another example, the configurable object may be designated as the guarded object by tagging the configurable object to designate the configurable object as the guarded object.

At 304, a request may be received to access the guarded object. At 306, a check may be made to determine whether the request is received from a user having a privilege to access the guarded object.

At 308, the access to the guarded object may be controlled based on the determination. In an example, controlling the access to the guarded object may include denying the access to the guarded object in response to a determination that the user is not having the privilege to access the guarded object. Further, a notification may be sent to an owner of the guarded object upon denying the access. The notification may indicate an attempt to access the guarded object by the user. In another example, controlling the access to the guarded object may include permitting the access to the guarded object in response to a determination that the user is having the privilege to access the guarded object.

Further, example method 300 may include tracking an event associated with the guarded object. In an example, the event may include at least one information corresponding to the user, whether the access to the guarded object is permitted or denied, and a change to the configurable object. Furthermore, example method 300 may include maintaining an audit trail to record the tracked event.

FIG. 4 is a block diagram of an example computing device 400 including non-transitory computer-readable storage medium 404 storing instructions to manage a restricted operation on a guarded object. Computing device 400 (e.g., management node 100 of FIG. 1) may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404.

Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to computing device 400.

Machine-readable storage medium 404 may store instructions 406-412. In an example, instructions 406-412 may be executed by processor 402 to manage a restricted operation on a guarded object. Instructions 406 may be executed by processor 402 to designate a configurable object as a guarded object to disable a restricted operation on the configurable object. In an example, instructions to designate the configurable object as the guarded object may include instructions to make a change to a configuration setting of the configurable object to designate the configurable object as the guarded object. In another example, instructions to designate the configurable object as the guarded object may include instructions to tag the configurable object to designate the configurable object as the guarded object.

Instructions 408 may be executed by processor 402 to receive a request to perform the restricted operation on the guarded object. Instructions 410 may be executed by processor 402 to determine whether the request is received from a user having a privilege to perform the restricted operation on the guarded object.

Instructions 412 may be executed by processor 402 to permit to perform the restricted operation on the guarded object based on the determination. In an example, instructions to permit to perform the restricted operation on the guarded object may include instructions to permit to perform the restricted operation on the guarded object in response to a determination that the user is having the privilege to perform the restricted operation on the guarded object.

In another example, machine-readable storage medium 404 may further store instructions to be executed by processor 402 to deny performing the restricted operation on the guarded object in response to a determination that the user is not having the privilege to perform the restricted operation on the guarded object. Further, machine-readable storage medium 404 may further store instructions to be executed by processor 402 to send a notification to an owner of the guarded object upon denying performing the restricted operation. In an example, the notification may indicate an attempt to perform the restricted operation on the guarded object by the user.

Machine-readable storage medium 404 may further store instructions to be executed by processor 402 to track an event associated with the guarded object. In an example, the event may include at least one information corresponding to the user, whether the access to the guarded object is permitted or denied, and a change to the configurable object. Machine-readable storage medium 404 may further store instructions to be executed by processor 402 to maintain an audit trail to record the tracked event.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computer implemented method comprising:
designating a configurable object as a guarded object to restrict access to the configurable object;
receiving a request to access the guarded object;
determining whether the request is received from a user having a privilege to access the guarded object; and
controlling the access to the guarded object based on the determination.

2. The computer implemented method of claim 1, further comprising:
tracking an event associated with the guarded object, the event comprises at least one information corresponding to the user, whether the access to the guarded object is permitted or denied, and a change to the configurable object; and
maintaining an audit trail to record the tracked event.

3. The computer implemented method of claim 1, wherein controlling the access to the guarded object comprises:
denying the access to the guarded object in response to a determination that the user is not having the privilege to access the guarded object.

4. The computer implemented method of claim 3, further comprising:
sending a notification to an owner of the guarded object upon denying the access, wherein the notification is to indicate an attempt to access the guarded object by the user.

5. The computer implemented method of claim 1, wherein controlling the access to the guarded object comprises:
permitting the access to the guarded object in response to a determination that the user is having the privilege to access the guarded object.

6. The computer implemented method of claim 1, wherein the configurable object is designated as the guarded object by:
making a change to a configuration setting of the configurable object to designate the configurable object as the guarded object; or
tagging the configurable object to designate the configurable object as the guarded object.

7. The computer implemented method of claim 1, wherein the configurable object comprises a configurable hardware component, virtual component, storage component, or networking component in a cloud computing infrastructure.

8. A management node comprising:
an inventory manager to:
enable a first user to create a configurable object;
designate the configurable object as a guarded object to restrict an operation to be performed on the guarded object; and
receive a request to perform the operation on the guarded object from a second user;
a tracking unit to:
determine whether the second user has a privilege to perform the operation on the guarded object; and
permit the second user to perform the operation on the guarded object when the second user has the privilege to perform the operation; and
an audit controller to maintain an audit trail to record the information corresponding to the second user, an access to the guarded object is permitted or denied, and/or a change to the guarded object.

9. The management node of claim 8, wherein the inventory manager is to:
enable the first user or an administrator to assign the privilege to the second user upon creating the configurable component.

10. The management node of claim 8, wherein the tracking unit is to deny the request to perform the operation on the guarded object when the second user is not having the privilege to perform the operation.

11. The management node of claim 10, further comprising:
a notification unit to send a notification to the first user upon denying the request to perform the operation, the notification is to indicate that the second user has attempted to access the guarded object.

12. The management node of claim 8, further comprising:
an object inventory to store configuration information of the configurable object indicating whether the configurable object is designated as the guarded object.

13. The management node of claim 8, wherein the inventory manager is to:
enable to make a change to a configuration setting of the configurable object to designate the configurable object as the guarded object; or
enable to tag the configurable object to designate the configurable object as the guarded object.

14. The management node of claim 8, wherein the configurable object comprises a configurable hardware component, virtual component, storage component, or networking component in a cloud computing infrastructure.

15. A non-transitory machine-readable storage medium encoded with instructions that, when executed by a processor of a computing device, cause the processor to:
designate a configurable object as a guarded object to disable a restricted operation on the configurable object;
receive a request to perform the restricted operation on the guarded object;
determine whether the request is received from a user having a privilege to perform the restricted operation on the guarded object; and
permit to perform the restricted operation on the guarded object based on the determination.

16. The non-transitory machine-readable storage medium of claim 15, further comprising instructions that, when executed by the processor, cause the processor to:
track an event associated with the guarded object, wherein the event comprises at least one information corresponding to the user, whether the access to the guarded object is permitted or denied, and a change to the configurable object; and
maintain an audit trail to record the tracked event.

17. The non-transitory machine-readable storage medium of claim 15, further comprising instructions that, when executed by the processor, cause the processor to:
deny performing the restricted operation on the guarded object in response to a determination that the user is not having the privilege to perform the restricted operation on the guarded object.

18. The non-transitory machine-readable storage medium of claim 17, further comprising instructions that, when executed by the processor, cause the processor to:
send a notification to an owner of the guarded object upon denying performing the restricted operation, wherein the notification is to indicate an attempt to perform the restricted operation on the guarded object by the user.

19. The non-transitory machine-readable storage medium of claim 15, wherein instructions to permit to perform the restricted operation on the guarded object comprise instructions to:
permit to perform the restricted operation on the guarded object in response to a determination that the user is having the privilege to perform the restricted operation on the guarded object.

20. The non-transitory machine-readable storage medium of claim 15, wherein instructions to designate the configurable object as the guarded object comprise instructions to:
make a change to a configuration setting of the configurable object to designate the configurable object as the guarded object; or
tag the configurable object to designate the configurable object as the guarded object.
